(19) United States
(12) Patent Application Publication
(10) Pub. No.: US 2026/0142143 A1
(43) Pub. Date: May 21, 2026

(54) METHOD OF MANUFACTURING BATTERY CELL

(71) Applicant: Prime Planet Energy & Solutions, Inc., Tokyo (JP)

(72) Inventor: Tetsuya SAKAKIBARA, Nagoya-shi (JP)

(21) Appl. No.: 19/362,484

(22) Filed: Oct. 20, 2025

(30) Foreign Application Priority Data
Nov. 18, 2024 (JP) 2024-200632

(51) Int. Cl. H01M 4/04

(52) U.S. Cl. CPC H01M 4/0435; H01M 4/0471

(57) ABSTRACT

A method of manufacturing a battery cell including a dry electrode body formed by pressing a self-supporting electrode film having an electrode active material, a conductive material, and a binder, and an electrode foil with a primer coat layer formed on an upper surface, by a press roll, and bonding them via the primer coat layer is provided. The method includes a heating process of heating at least one of bonding surfaces at which the self-supporting electrode film and the electrode foil are bonded to each other to a required temperature, and a bonding process of pressing the self-supporting electrode film and the electrode foil by the press roll and bonding the self-supporting electrode film and the electrode foil to each other after the heating process.

### CROSS-REFERENCE TO RELATED APPLICATIONS

This application is based upon and claims the benefit of priority to Japanese Patent Application No. 2024-200632 filed on Nov. 18, 2024, the entire contents of which are incorporated herein by reference.

### BACKGROUND

### Technical Field

The present disclosure relates to a method of manufacturing battery cells for use in hybrid vehicles, electric vehicles, etc.

### Related Art

In a known method of manufacturing a battery cell, an electrode body is formed by coating an electrode foil with a coating liquid obtained by mixing an electrode active material and additives such as a conductive material and a binder with a solvent to form a paste, and then drying it. However, in this method, the drying process for evaporating the solvent undesirably takes a significant amount of time. If the heating temperature during the drying process is rapidly increased to shorten this time, uneven distribution of the binder may occur due to solvent convection, and an electrode active material layer and the electrode foil may easily peel off from each other.

Therefore, in recent years, the development of dry electrode bodies has been attracting attention. For example, Japanese unexamined patent application publication No. 2023-517975 (JP 2023-517975 A) discloses a method of manufacturing a dry electrode body by bonding a free-standing film (self-supporting electrode film) having an electrode active material, a conductive material, and a binder containing a fibrous polymer to an electrode foil coated with a primer layer, while pressing them by a heated lamination roll.

### SUMMARY

### Technical Problems

In the above method, the self-supporting electrode film and the electrode foil are pressed by heated opposed rolls when they are bonded to each other. Therefore, the temperature of the rolls is transmitted to the bonding surfaces of the self-supporting (standing) electrode film and the electrode foil only when they pass through the gap between the rolls, thus making it difficult to heat the bonding surfaces of the self-supporting electrode film and the electrode foil to the required temperature. Thus, it is necessary to raise the temperature of the rolls to a temperature higher than necessary and maintain the temperature, resulting in a significant energy loss.

The disclosure was made in view of the above problem, and provides a method of manufacturing a battery cell, which can reduce an energy loss associated with heating when a dry electrode body is produced by heating a self-supporting electrode film and an electrode foil and bonding them to each other.

### Means of Solving the Problems

(1) One aspect of the disclosure for solving the above problem is a method of manufacturing a battery cell including a dry electrode body that includes a self-supporting electrode film having an electrode active material, a conductive material, and a binder, and an electrode foil with a primer coat layer formed on an upper surface, wherein the self-supporting electrode film and the electrode foil are pressed by a press roll and bonded to each other via the primer coat layer. The method includes a heating process of heating at least one of bonding surfaces at which the self-supporting electrode film and the electrode foil are bonded to each other to a required temperature, and a bonding process of pressing the self-supporting electrode film and the electrode foil by the press roll and bonding the self-supporting electrode film and the electrode foil to each other after the heating process.
(2) In the method of manufacturing the battery cell described in (1) above, the primer coat layer may contain graphite particles as a conductive material, and in the heating process, laser light may be applied to the primer coat layer to heat the bonding surface of the electrode foil.
(3) The method of manufacturing the battery cell described in (1) or (2) above may further include a coating process of coating the electrode foil with the primer coat layer, and a drying process of drying the primer coat layer applied to the electrode foil, wherein the drying process comprises the heating process of heating the bonding surface of the electrode foil to the required temperature.
(4) In the method of manufacturing the battery cell described in any one of (1) to (3) above, the press roll may be equipped with a roll controller that controls a gap between rolls of the press roll to be constant.

### BRIEF DESCRIPTION OF THE DRAWINGS

FIG. 1 is a side view of a battery cell formed by a manufacturing method of the battery cell according to one embodiment of the disclosure;

FIG. 2 is a part of a flowchart of the manufacturing method of the battery cell shown in FIG. 1, showing the process of manufacturing a dry electrode body;

FIG. 3 is a schematic cross-sectional view schematically illustrating the process of manufacturing the dry electrode body shown in FIG. 2; and

FIG. 4 is a schematic cross-sectional view of part A shown in FIG. 3.

### DETAILED DESCRIPTION OF THE EXEMPLARY EMBODIMENTS

### Overall Description of Battery Cell

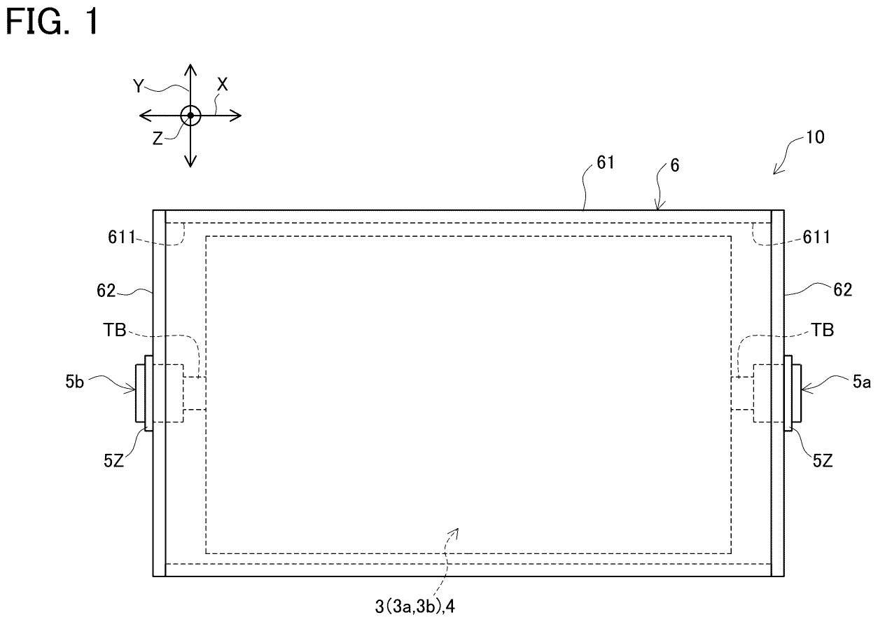

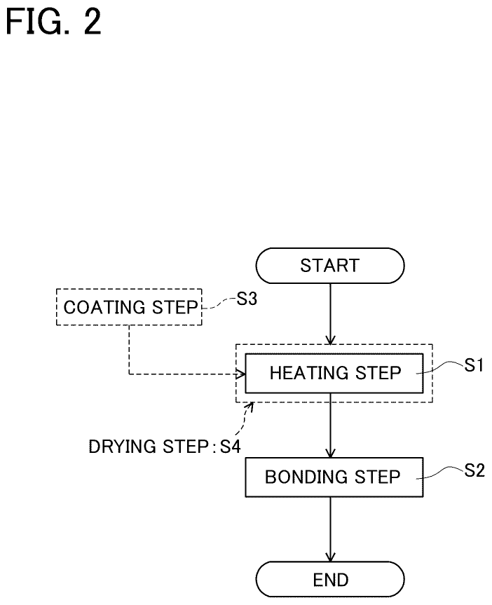

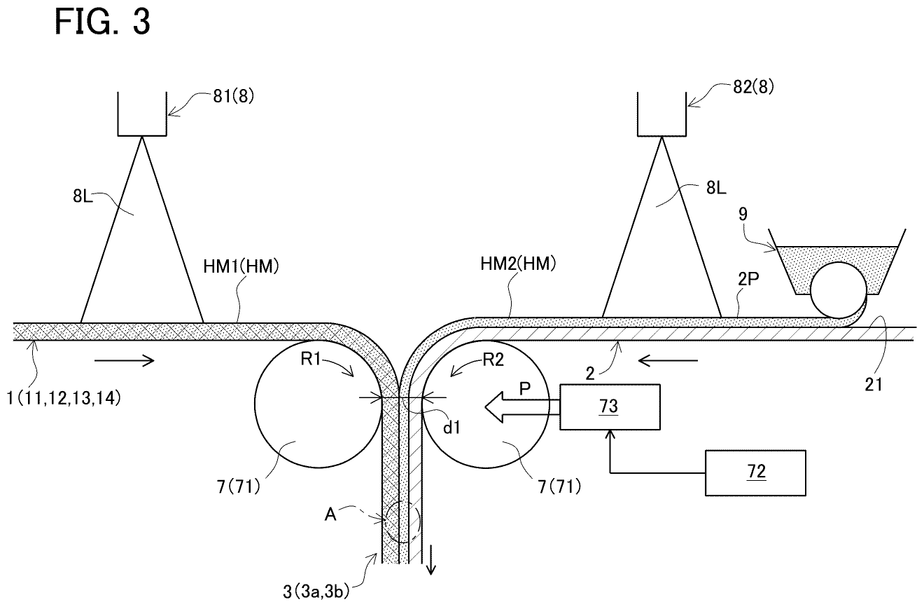

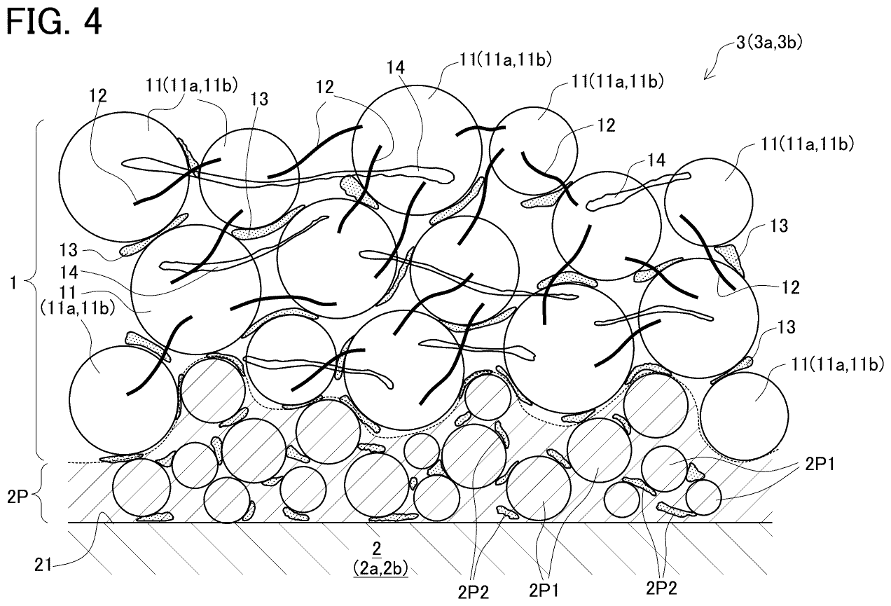

Next, the overall configuration of a battery cell formed by a manufacturing method of the battery cell according to an embodiment of the disclosure will be described in detail with reference to the drawings (FIG. 1 to FIG. 4). FIG. 1 is a side view of the battery cell formed by the manufacturing method of the battery cell according to one embodiment of the disclosure. FIG. 2 is a part of a flowchart of the manufacturing method of the battery cell shown in FIG. 1, showing the process of manufacturing a dry electrode body. FIG. 3 is a schematic cross-sectional view schematically illustrating the dry electrode body manufacturing process shown in FIG. 2. FIG. 4 is a schematic cross-sectional view of part A shown in FIG. 3. In FIG. 1, the X direction indicates the longitudinal direction (axial direction) of a case body, the Y direction indicates the transverse direction of the case body, and the Z direction indicates the width direction of a short side face of the case body. The X direction is also the width direction of an electrode foil, the Y direction is also the longitudinal direction of the electrode foil, and the Z direction is also the laminating direction of the electrode foil.

As shown in FIG. 1 to FIG. 4, the battery cell 10 includes a dry electrode body 3 formed by pressing a self-supporting electrode film 1 having an electrode active material 11, a conductive material 12, and binders 13, 14, and an electrode foil 2 with an upper surface 21 on which a primer coat layer 2P is formed, using a press roll 7, to bond the self-supporting electrode film 1 and the electrode foil 2 to each other via the primer coat layer 2P.

Here, the self-supporting electrode film 1 having a predetermined thickness that enables the film 1 to stand by itself is formed by applying shear force to a mixture containing, for example, the electrode active material 11, the conductive material 12, and the binders 13, 14, and includes the binder 14 that has been fiberized by the shear force. The conductive material 12 may be, for example, carbon nanotube (CNT), carbon black (CB), etc. The binders 13, 14 may be, for example, polytetrafluoroethylene (PTFE), polyvinylidene fluoride (PVDF), etc. The primer coat layer 2P includes a conductive material 2P1 such as graphite particles, and a binder 2P2, which are mixed with an appropriate solvent and applied to the electrode foil 2. The binder 2P2 may be, for example, polyvinylidene fluoride (PVDF), styrene-butadiene rubber (SBR), etc., and may be either a thermoplastic resin or a thermosetting resin. The dry electrode body 3 comprises a dry electrode body 3a of the positive electrode and a dry electrode body 3b of the negative electrode which are laminated with a separator 4 interposed therebetween.

As shown in FIG. 1, the battery cell 10 includes a battery case 6 that houses the dry electrode body 3. Here, the battery case 6 includes a quadrangular tube-like case body 61 having rectangular openings 611 at both ends in the longitudinal direction (the X direction), and lids 62 in the form of flat plates that seal the openings 611. A positive current collecting terminal 5a connected to a tab portion TB of the dry electrode body 3a of the positive electrode and a negative current collecting terminal 5b connected to a tab portion TB of the dry electrode body 3b of the negative electrode are fixed to the respective lids 62 via an insulating material 5Z. The insulating material 5Z may be, for example, polyphenylene sulfide (PPS) resin.

The battery case 6 is not necessarily limited to the above structure. For example, the battery case 6 may include a tube-like case body 61 with a bottom, which has an opening 611 at one end in the longitudinal direction (the X direction), and a lid 62 in the form of a flat plate that seals the opening 611. The case body 61 may also be cylindrical. The case body 61 and the lids 62 are made of aluminum, but they are not necessarily limited to aluminum and may be made of stainless steel, for example.

While the battery cell 10 may be applied to various types of battery cells, a lithium-ion secondary battery will be illustrated by way of example. In this case, an aluminum foil of about 10 to 15 μm thickness, for example, may be used as a positive electrode foil 2a, and a lithium transition metal oxide (such as LiNi_{1/3}Co_{1/3}Mn_{1/3}O₂, and LiNiO₂), for example, may be used as an electrode active material 11a. A copper foil of about 10 to 15 μm thickness, for example, may be used as a negative electrode foil 2b, and graphite, hard carbon, soft carbon, etc. may be used as an electrode active material 11b. An aluminum sheet may be used as the positive current collecting terminal 5a, and a copper sheet may be used as the negative current collecting terminal 5b. A porous sheet of polypropylene or polyethylene, for example, may be used as the separator 4.

### Manufacturing Method of Battery Cell

Next, the manufacturing method of the battery cell will be described in detail with reference to the drawings (FIG. 1 to FIG. 4). Specifically, the manufacturing method of the battery cell is the method of manufacturing the battery cell 10 including the dry electrode body 3 formed by pressing the self-supporting electrode film 1 having the electrode active material 11, the conductive material 12, and the binders 13, 14 and the electrode foil 2 with the upper surface 21 on which the primer coat layer 2P is formed, using the press roll 7, and bonding the self-supporting electrode film 1 and the electrode foil 2 to each other via the primer coat layer 2P, as shown in FIG. 1 to FIG. 4. The manufacturing method includes a heating step S1 of heating at least one bonding surface HM of respective bonding surfaces HM (HM1, HM2) at which the self-supporting electrode film 1 and the electrode foil 2 are bonded to each other, to a required temperature, and a bonding step S2 following the heating step S1, of pressing the self-supporting electrode film 1 and the electrode foil 2 by the press roll 7 and bonding them together. The press roll 7 comprises opposed cylindrical rolls 71, 71 that rotate in opposite directions R1, R2 at the same circumferential speed. Here, a pressing device 73 is mounted to apply a predetermined pressing force P to one of the rolls 71 that contacts the electrode foil 2 to press it against the other roll 71 that contacts the self-supporting electrode film 1.

The method of manufacturing the battery cell 10 also includes an electrode film forming step of forming the self-supporting electrode film 1, an electrode foil forming step of forming the electrode foil 2 coated with the primer coat layer 2P, and so forth, as pre-steps of the heating step S1. In addition, the manufacturing method includes a battery assembling step of storing the dry electrode body 3 formed by laminating the dry electrode body 3a of the positive electrode and the dry electrode body 3b of the negative electrode with the separator 4 interposed therebetween, in the battery case 6, and sealing the battery case 6, an adjusting step of initial charging and aging, and so forth, as post-steps of the bonding step S2. Each of the above steps is a known step, and thus will not be described herein.

As described above, the method of manufacturing the battery cell 10 includes the heating step S1 of heating at least one bonding surface HM of the respective bonding surfaces HM (HM1, HM2) at which the self-supporting electrode film 1 and the electrode foil 2 are bonded to each other, to the required temperature, before pressing the self-supporting electrode film 1 and the electrode foil 2 on which the primer coat layer 2P is formed, using the press roll 7, and bonding them. Therefore, it is possible to heat the bonding surfaces HM of the self-supporting electrode film 1 and the electrode foil 2 to the required temperature for bonding, without directly heating the press roll 7. The thermal energy required for the heating can be significantly reduced compared to heating the bonding surfaces HM of the self-supporting electrode film 1 and the electrode foil 2 via the press roll 7 heated, thereby reducing energy loss. Thus, the method of manufacturing the battery cell 10, which can reduce energy loss associated with heating when producing the dry electrode body 3 by heating and bonding the self-supporting electrode film 1 and the electrode foil 2, can be provided.

As shown in FIG. 2 and FIG. 3, in the heating step S1, the bonding surface HM1 of the self-supporting electrode film 1 conveyed horizontally toward the press roll 7 is heated by a heating device 81, and the bonding surface HM2 of the electrode foil 2 conveyed horizontally from the opposite side toward the press roll 7 is heated by another heating device 82. The heating device 8 (81, 82) preferably irradiates each of the bonding surfaces HM1, HM2 with laser light 8L that has been diffused uniformly over a plane so as to uniformly heat both the self-supporting electrode film 1 and the primer coat layer 2P of the electrode foil 2. The planar laser light 8L is formed, for example, when laser light 8L from a semiconductor laser passes through a special homogenizer such as a six-sided ground rod. The heating devices 8 (81, 82) are not necessarily limited to the one that radiates planar laser light 8L diffused uniformly over a plane. For example, the heating devices 8 (81, 82) may emit far-infrared rays from planar heat-generating elements such as ceramics.

The heating temperature of the bonding surfaces HM1, HM2 is preferably set within the use temperature ranges of the binders 13, 14, 2P2 of the self-supporting electrode film 1 and the primer coat layer 2P. When the binder is, for example, polytetrafluoroethylene (PTFE), the bonding surfaces HM1, HM2 can be heated at about 250° C. When the binder is polyvinylidene fluoride (PVDF), the bonding surfaces HM1, HM2 can be heated at about 150° C. In this case, as shown in FIG. 4, the conductive material 2P1, such as graphite particles, of the primer coat layer 2P gets into gaps between the electrode active materials 11 of the softened self-supporting electrode film 1, thereby enhancing the anchoring effect while improving conductivity.

Even in the case where one bonding surface HM of the respective bonding surfaces HM (HM1, HM2) at which the self-supporting electrode film 1 and the electrode foil 2 are bonded to each other is heated to the required temperature, when the self-supporting electrode film 1 and the electrode foil 2 are pressed by the press roll 7, the heat of the heated bonding surface HM is transmitted to the other bonding surface HM, thereby enhancing the anchoring effect while improving conductivity between the self-supporting electrode film 1 and the electrode foil 2 in the bonded state.

In the method of manufacturing the battery cell 10, it is preferable that the primer coat layer 2P formed on the upper surface 21 of the electrode foil 2 contains graphite particles as the conductive material 2P1, and, in the heating step S1, the laser light 8L is applied to the primer coat layer 2P to heat the bonding surface HM2 of the electrode foil 2. The weight ratio of the graphite particles 2P1 in the primer coat layer 2P is preferably about 80 to 90%. In this case, the light absorption rate of the laser light 8L into the primer coat layer 2P can be improved by the graphite particles 2P1, and the thermal energy required for heating the electrode foil 2 can be further reduced.

As shown in FIG. 2 and FIG. 3, it is preferable that the method of manufacturing the battery cell 10 includes a coating step S3 of coating the electrode foil 2 with the primer coat layer 2P and a drying step S4 of drying the primer coat layer 2P applied in the coating step S3, and that the drying step S4 also serves as the heating step S1 of heating the bonding surface HM2 of the electrode foil 2 to the required temperature. Here, a coating device 9 for the primer coat layer 2P is mounted at a position adjacent to and upstream of the heating device 82 with respect to the feeding direction of the electrode foil 2. The heating device 82 heats the bonding surface HM2 of the electrode foil 2, thereby evaporating the solvent contained in the primer coat layer 2P applied by the coating device 9, and heating the bonding surface HM2 of the electrode foil 2 to the required temperature necessary for bonding. Thus, the heating device 82 performs both the functions of the heating step S1 and the drying step S4.

In this case, the thermal energy used to dry the primer coat layer 2P in the drying step S4 can be effectively used to heat the bonding surfaces HM at which the self-supporting electrode film 1 and the electrode foil 2 are bonded to each other to the required temperature necessary for bonding. Therefore, the thermal energy required for heating the bonding surfaces HM can be further reduced. In addition, since the primer coat layer 2P can be heated to the required temperature necessary for bonding the self-supporting electrode film 1 and the electrode foil 2 in the drying step S4, the dry electrode body 3 in which the self-supporting electrode film 1 and the electrode foil 2 are bonded to each other can be easily formed by pressing the self-supporting electrode film 1 and the electrode foil 2 by the press roll 7 immediately after the heating. In this case, there is no need to temporarily store the electrode foil 2 with the primer coat layer 2P formed thereon.

In the method of manufacturing the battery cell 10, as shown in FIG. 3, the press roll 7 is preferably equipped with a roll controller 72 that controls the gap d1 between the rolls 71, 71 to be constant. Here, there are provided the pressing device 73 that presses one of the rolls 71, 71 that constitute the press roll 7 against the other roll 71, and the roll controller 72 that calculates the gap d1 between the rolls 71, 71 based on the amount of movement of the roll 71 by the pressing device 73 and controls the gap d1 to be constant.

In this case, even if the temperature of the roll 71 rises and the roll diameter increases due to heating of the bonding surface HM to the required temperature in the heating step S1, the roll controller 72 can command the pressing device 73 to keep the gap d1 between the rolls 71, 71 constant. As a result, the pressing force P of the press roll 7 applied to the self-supporting electrode film 1 and the electrode foil 2 can be maintained at a predetermined pressure. Therefore, excessive stretching, breakage, etc. of the self-supporting electrode film 1 and the electrode foil 2 can be curbed.

### Modified Examples

The embodiment described in detail is a mere example and does not limit the disclosure in any way. Thus, various improvements and modifications of the disclosure are possible within the scope that does not depart from the principle thereof.

### REFERENCE SIGNS LIST

1 Self-supporting electrode film
2 Electrode foil
2P Primer coat layer
2P1 Conductive material, Graphite particle
3 Dry electrode body
7 Press roll
8L Laser light
10 Battery cell
11 Electrode active material
12 Conductive material
13, 14 Binder
21 Upper surface
71 Roll
72 Roll controller
HM, HM1, HM2 Bonding surface
S1 Heating step
S2 Bonding step
S3 Coating step
S4 Drying step

What is claimed is:

1. A method of manufacturing a battery cell including a dry electrode body that includes a self-supporting electrode film having an electrode active material, a conductive material, and a binder, and an electrode foil with a primer coat layer formed on an upper surface, wherein the self-supporting electrode film and the electrode foil are pressed by a press roll and bonded to each other via the primer coat layer, the method comprising:
heating at least one of bonding surfaces at which the self-supporting electrode film and the electrode foil are bonded to each other to a required temperature; and
pressing the self-supporting electrode film and the electrode foil by the press roll and bonding the self-supporting electrode film and the electrode foil to each other after the heating.

2. The method of manufacturing the battery cell according to claim 1, wherein:
the primer coat layer contains graphite particles as a conductive material; and
in the heating, laser light is applied to the primer coat layer to heat the bonding surface of the electrode foil.

3. The method of manufacturing the battery cell according to claim 1, further comprising:
coating the electrode foil with the primer coat layer; and
drying the primer coat layer applied to the electrode foil,
wherein the drying comprises heating the bonding surface of the electrode foil to the required temperature.

4. The method of manufacturing the battery cell according to claim 2, further comprising:
coating the electrode foil with the primer coat layer; and
drying the primer coat layer applied to the electrode foil,
wherein the drying comprises heating the bonding surface of the electrode foil to the required temperature.

5. The method of manufacturing the battery cell according to claim 1, wherein the press roll is equipped with a roll controller that controls a gap between rolls of the press roll to be constant.

6. The method of manufacturing the battery cell according to claim 2, wherein the press roll is equipped with a roll controller that controls a gap between rolls of the press roll to be constant.

7. The method of manufacturing the battery cell according to claim 3, wherein the press roll is equipped with a roll controller that controls a gap between rolls of the press roll to be constant.
